(19) United States
(12) Patent Application Publication
(10) Pub. No.: US 2014/0260656 A1
(43) Pub. Date: Sep. 18, 2014

(54) DESTRUCTIVE TESTING DEVICE AND METHOD

(71) Applicant: HON HAI PRECISION INDUSTRY CO., LTD., New Taipei (TW)

(72) Inventor: CHIH-HAO CHU, New Taipei (TW)

(73) Assignee: HON HAI PRECISION INDUSTRY CO., LTD., New Taipei (TW)

(21) Appl. No.: 14/016,204

(22) Filed: Sep. 2, 2013

(30) Foreign Application Priority Data
Mar. 15, 2013 (TW) 102109145

(51) Int. Cl. G01N 3/08

(52) U.S. Cl. CPC G01N 3/08
USPC 73/818

(57) ABSTRACT

A destructive testing device includes an upper mold, a lower mold, a pressure gauge, and a lifting module. The lower mold is opposite to the upper mold. The pressure gauge is connected to the upper mold, and is configured for recording a pressure applied on the upper mold. The lifting module is connected to the lower mold, and is configured for moving the lower mold toward the upper mold.

### BACKGROUND

1. Technical Field

The present disclosure relates to destructive testing devices, and particularly to a destructive testing device and a method used for testing a destructive force of a lens separating from a lens barrel receiving the lens.

2. Description of Related Art

Lens modules include a lens and a lens barrel receiving the lens. To ensure quality, the lens modules need to pass various tests, such as a destructive test. One of values needs to be determined in the destructive values a destructive force to separate the lens from the lens barrel. However, as the lens is received in and adhered to the lens barrel, it is hard to test a destructive force of the lens separating from the lens barrel.

Therefore, it is desirable to provide a destructive testing device and a method that can overcome the limitations described.

### BRIEF DESCRIPTION OF THE DRAWINGS

FIG. 1 is an isometric view of a destructive testing device in accordance with an exemplary embodiment.

FIG. 2 is a flowchart of a destructive testing method in accordance with an exemplary embodiment.

### DETAILED DESCRIPTION

Embodiments of the disclosure will be described with reference to the drawings.

FIG. 1 shows a destructive testing device 10, according to an exemplary embodiment. The device 10 is used to test a destructive force of a lens 202 of a lens module 20 separating from a lens barrel 201 receiving the lens 202. The lens barrel 101 includes an object side 203 and an image side 204 opposite to the object side 203. The lens barrel 101 defines a receiving hole 205 running through the object side 203 and the image side 204. The lens 202 is received in the receiving hole 205 and is adhered to the lens barrel 201 via glue (not shown).

The destructive testing device 10 includes an upper mold 11, a lower mold 12, a pressure gauge 13, and a lifting module 14.

The upper mold 11 includes a top end portion 110 and a connecting portion 111. The top end portion 110 is cone shaped and a maximum external diameter of the top end portion 110 is less than an internal diameter of the receiving hole 205. The connecting portion 111 is connected to an end of the top end portion 110 with the maximum external diameter.

The lower mold 12 includes a supporting portion 120 and a supporting platform 121. The supporting portion 120 is cylindrical and defines a through hole 120a running through two ends. The through hole 120a is adjacent to a center of the supporting portion 120. An internal diameter of the through hole 120a is greater than an external diameter of the lens 202, and is less than a external diameter of the lens barrel 201. The through hole 120a is opposite to the top end portion 110. The lens module 20 is supported on the supporting portion 120, and the through hole 120a is used to receive the lens 202 separating from the lens barrel 201. The supporting portion 120 is supported on the supporting platform 121.

It should be understood that the through hole 120a can be omitted and the lens 202 lies on the supporting portion 120.

The pressure gauge 13 is connected to the upper mold 11 and is configured for measuring a pressure applied on the top end portion 110. In the embodiment, the pressure gauge 13 is connected to one end of the connecting portion 111 facing away the top end portion 110.

The lifting module 14 is connected to the lower mold 12 and is configured for rising and lowering the lower mold 12. The lifting module 14 includes a driving pole 140, an operating box 141, and a hand wheel 142. A part of the driving pole 140 protrudes from the operating box 141. The hand wheel 142 is rotatably installed on a side of the operating box 141. A height of the driving pole 140 protruding from the operating box 141 is adjusted by rotating the hand wheel 142. One end of the driving pole 140 protruding from the operating box 141 is connected to the supporting platform 121.

It should be understood that the supporting platform 121 can be omitted and the driving pole 140 is directly connected to the supporting portion 120.

In test, the lens module 20 is placed upon the supporting portion 120, the receiving hole 205 is aligned with the through hole 120a. The height of the driving pole 140 protruding from the operating box 141 is gradually increased by rotating the hand wheel 142, and the lens barrel 201 sleeves the top end portion 110. As the top end portion 110 contacts the lens 202, the pressure gauge 13 indicates the pressure applied on the lens 202. When the lens 202 separates from the lens barrel 201, the pressure gauge 13 records the destructive force of the lens 202 separating from the lens barrel 201.

FIG. 2 shows a destructive testing method, according to an exemplary embodiment, used to test the destructive force of the lens 202 separating from the lens barrel 201. The destructive testing method includes steps S101-S104.

S101: a destructive testing device 100 is provided. The destructive testing device 100 includes an upper mold 11, a lower mold 12, a pressure gauge 13, and a lifting module 14. The pressure gauge 13 is connected to the upper mold 11, and the lifting module 14 is connected to the lower mold 12.

S102: the lens module 20 is placed on the lower mold 12.

S103: the lifting module 14 drives the lower mold 12 to move toward the lower mold 12.

S104: the pressure gauge 13 records a pressure applied on the upper mold 11 when the lens 202 is separating from the lens barrel 201. In the embodiment, the pressure recorded by pressure gauge 13 is the destructive force of the lens 202 separating from the lens barrel 201.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A destructive testing device, comprising:
an upper mold;
a lower mold opposite to the upper mold;
a pressure gauge connected to the upper mold, and configured for recording a pressure applied on the upper mold; and
a lifting module connected to the lower mold, and configured for moving the lower mold toward the upper mold.

2. The destructive testing device of claim 1, wherein the upper mold comprises a top end portion and a connecting portion connected to the top end portion.

3. The destructive testing device of claim 2, wherein the top end portion is cone shaped.

4. The destructive testing device of claim 2, wherein the pressure gauge is connected to the connecting portion.

5. The destructive testing device of claim 1, wherein the lower mold comprises a supporting portion and a supporting platform connected to the supporting portion.

6. The destructive testing device of claim 5, wherein the supporting portion defines a through hole running through two ends thereof.

7. The destructive testing device of claim 5, wherein the lifting module is connected to the supporting platform.

8. The destructive testing device of claim 1, wherein the lifting module comprises a driving pole, an operating box, and a hand wheel; the driving pole partially protrudes from the operating box, the hand wheel is rotatably installed on a side of the operating box, a height of the driving pole protruding from the operating box is adjusted by rotating the hand wheel.

9. A destructive testing method for testing a destructive force of a lens separating from a lens barrel receiving the lens, comprising:
providing a destructive testing device comprising an upper mold, a lower mold, a pressure gauge, and a lifting module; the pressure gauge connected to the upper mold, and the lifting module connected to the lower mold;
placing a lens module on the lower mold, the lens module comprising the lens and the lens barrel;
driving the lower mold to move toward the upper mold by the lifting module; and
recording a pressure applied on the upper mold by the pressure gauge.
